(19) United States
(12) Patent Application Publication
(10) Pub. No.: US 2007/0091209 A1
(43) Pub. Date: Apr. 26, 2007

(54) Apparatus to control the text of broadcasted data and a method of controlling the text of broadcasted data

(75) Inventor: Ji-yeon Kwak, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/582,468

(22) Filed: Oct. 18, 2006

(30) Foreign Application Priority Data
Oct. 24, 2005 (KR) 2005-100433

(51) Int. Cl. H04N 5/445; H04N 9/74

(52) U.S. Cl. 348/589; 348/564

(57) ABSTRACT

An apparatus to allow for a control of texts of broadcasted data, including a display unit to display the texts when the broadcasted data is received, a button signal input unit to receive button signals inputted by a user, and a text size adjusting unit to adjust sizes of the displayed texts according to directions indicated by the inputted button signals.

### CROSS-REFERENCE TO RELATED APPLICATION

This application claims the benefit of Korean Application No. 2005-0100433, filed Oct. 24, 2005 in the Korean Intellectual Property Office, the disclosure of which is incorporated herein by reference.

### BACKGROUND OF THE INVENTION

1. Field of the Invention

Aspects of the present invention relate to an apparatus to control the text of broadcasted data and a method of controlling the text of broadcasted data, and, more particularly, to an apparatus to control texts of broadcasted data and a method of controlling text of broadcasted data, in which a user adjusts the size of text supplied to a display panel of a portable apparatus using directional buttons, and sets a method of loading the text displayed on a display panel.

2. Description of the Related Art

In recent years, digital broadcasting services have quickly spread through existing media, such as ground wave broadcasting, satellite broadcasting, cable TV broadcasting, or the like, which has resulted in innovative changes in broadcasting industry environments. One of these media is the DMB (Digital Multimedia Broadcasting) service, which is a new medium that is represented by a cooperation of digital broadcasting and digital communications entities.

A characteristic of the DMB service is that a user may watch multi-channel digital television broadcasting while on the move.

Before the DMB service is described, radio broadcasting, which is also currently being used, will be first described. Radio broadcasting using an analog system was originally developed for fixed reception. Thus, if the user receives the radio broadcast while walking or driving a vehicle, the sound quality of the radio broadcast is significantly lowered, and higher output and a wider frequency band are required.

In order to solve theses problems, efforts have been made around the world to standardize to digital audio broadcasting and make audio broadcasting more suitable for practical use. As a result, DAB (Digital Audio Broadcasting) has been used in Europe, where Eureka-147 has been adopted as a digital audio broadcasting standard, DAR (Digital Audio Radio) has been used in the United States, DRB (Digital Radio Broadcasting) has been used in Canada, DSB (Digital Sound Broadcasting) has been used by the International Telecommunication Union (ITU-R), and DMB (Digital Multimedia Broadcasting) has been used in Korea.

DAB that is developed for next generation broadcasting is sufficiently robust to be compatible with electromagnetic wave environments and noise in downtown areas. Therefore, even if a transmission is transmitted with low output, electric waves carrying sound with CD level quality may nevertheless be received in a vehicle that is moving at high speed. Further, thanks to DAB, the concept of radio broadcasting is broadened from the existing ‘listening’ broadcasting to ‘viewing and listening’ broadcasting. As such, according to the DAB service, in addition to music broadcasting, a variety of multimedia information, such as news, traffic information, weather information, geographic and location information, moving picture information, and the like, can be transmitted through characters and graphics.

Meanwhile, DMB, which was named by the Ministry of Information and Communication in Korea, is a next generation broadcasting technique, in which the sound broadcasting is digitized, with CD level sound quality that surpasses the level of existing AM and FM radio, and provides various data services, such as characters, graphics and moving pictures, at a data transmission speed of 1.5 Mbits/s, and provides bidirectional services, superior quality broadcasting reception while the receiver is on the move, or the like.

The above-mentioned DMB is largely divided into ground wave DMB and satellite DMB based on a transmission medium thereof. The satellite DMB service is divided into a fixed service and a mobile service.

Further, with the development of digital technologies, media using compression technologies have spread. Therefore, cooperation between communications, computers, and broadcasting will be accelerated, and, thus, data broadcasting that provides supplementary information as well as audio and video may be implemented.

According to data broadcasting using DMB, information may be multiplexed during a vertical retrace period of television video signals so as to transmit the multiplexed information. In addition, multimedia information, including character information, still videos, product information, and electronic program guide (EPG) information, may be provided through separate channels to users who have digital television receivers or computers.

Accordingly, through data broadcasting using DMB, users may receive news information about when or where various events and accidents occur, sports information, stock information in real time, newsflash information, such as geographic information, traffic information, or the like, which users may want to know in advance, mail order information that provides product information, and program guide information.

However, when data broadcasting using DMB is transmitted, very small text sizes may be displayed on the display panel of the portable apparatus, which makes reading the text difficult for the users.

Japanese Patent Application Publication No. 1996-263046 discloses a method of displaying characters and an apparatus for displaying characters. According to Japanese Patent Application Publication No. 1996-263046, the apparatus for displaying characters relates to an apparatus which quickly displays inputted characters in a longitudinal direction or a horizontal direction. Further, according to the method of displaying characters disclosed in Japanese Patent Application Publication No. 1996-263046, when the inputted characters are Chinese characters, the inputted characters are displayed in a longitudinal direction, and if the inputted characters are not Chinese characters, the inputted characters are displayed in a horizontal direction. However, according to this method, although both the longitudinal direction and the horizontal direction are used when the characters are displayed, it is simply described that the character displaying directions are determined depending on the determination result of whether the inputted characters are Chinese characters. Therefore, solving the above-described problems with the sizes of the displayed texts and the method of loading the texts is not possible.

### SUMMARY OF THE INVENTION

An aspect of the present invention is to provide an apparatus to allow for a controlling of texts of broadcasted data and a method of controlling the texts of broadcasted data, in which a user adjusts sizes of the texts supplied to a display panel of a portable apparatus using directional buttons.

Another aspect of the present invention is to provide an apparatus to allow for a controlling of texts of broadcasted data and a method of controlling the texts of broadcasted data, in which various methods of loading texts displayed on a display panel of a portable apparatus are achieved, such that a user may read the texts more easily.

According to a first aspect of the present invention, an apparatus to allow for a control of texts of broadcasted data, comprises a display unit to display the texts when the broadcasted data is received, a button signal input unit to receive button signals inputted by a user, and a text size adjusting unit to adjust sizes of the displayed texts according to directions indicated by the inputted button signals.

According to a second aspect of the present invention, an apparatus to allow for control of texts of broadcasted data, comprises a display unit to display predetermined texts when the broadcasted data is received, a button signal input unit to receive button signals inputted by a user, and a text loading method control unit to control a loading of the displayed texts according to the setting of the method of loading the texts inputted by the user.

According to a third aspect of the present invention, an apparatus to allow for a control of texts of broadcasted data, comprises a display panel to display predetermined texts when the broadcasted data is received, and an input unit to adjust sizes of the displayed texts.

According to a fourth aspect of the present invention, a method of controlling texts of broadcasted data includes displaying predetermined texts on a display panel, when the broadcasted data is received, receiving button signals inputted by a user, and adjusting sizes of the displayed texts according to directions indicated by the inputted button signals.

According to a fifth aspect of the present invention, a method of controlling texts of broadcasted data includes displaying predetermined texts on a display panel when the broadcasted data is received, receiving a method of loading the texts set by a user, and loading the texts on the display panel according to the method of loading the texts set by the user.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating an apparatus for controlling texts of broadcasted data according to an embodiment of the present invention;

FIG. 2 is a block diagram illustrating an inner structure of an apparatus for controlling texts of broadcasted data according to another embodiment of the present invention;

FIGS. 3A to 3C are diagrams illustrating an example where sizes of texts are adjusted in an apparatus for controlling texts of broadcasted data according to another embodiment of the present invention;

FIGS. 4A and 4B are diagrams illustrating a method of loading texts in an apparatus for controlling texts of broadcasted data according to another embodiment of the present invention;

FIG. 5 is a flowchart illustrating a process of adjusting sizes of displayed texts in a method of controlling texts of broadcasted data according to another embodiment of the present invention; and

FIG. 6 is a flowchart illustrating a process of loading texts in a method of controlling texts of broadcasted data according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The apparatus for and the method of providing a screen capturing function according to the present invention will now be described more fully with reference to the accompanying drawings, in which preferred embodiments of the present invention are shown. It is to be understood that blocks in the accompanying block diagrams and compositions of operations in flow charts can be performed by computer program instructions. These computer program instructions can be provided to processors of, for example, general-purpose computers, special-purpose computers, and programmable data processing apparatuses. Therefore, the instructions performed by the computer or the processors of the programmable data processing apparatus generate means for executing functions described in the blocks in block diagrams or the operations in the flow charts. The computer program instructions can be stored in a computer available memory or a computer readable memory of the computer or the programmable data processing apparatus in order to realize the functions in a specific manner. Therefore, the instructions stored in the computer available memory or the computer readable memory can manufacture products including the instruction means for performing the functions described in the blocks in the block diagrams or the operations in the flow charts. Also, the computer program instructions can be loaded onto the computer or the computer programmable data processing apparatus. Therefore, a series of operations is performed in the computer or the programmable data processing apparatus to generate a process executed by the computer, which makes it possible for the instructions driving the computer or the programmable data processing apparatus to provide operations of executing the functions described in the blocks of the block diagrams or the operations of the flow charts.

Each block or operation may indicate a portion of a module, a segment or a code including one or more executable instructions to perform a specific logical function (or functions). It should be noted that, in some modifications of the present invention, the functions described in the blocks or the operations may be generated out of order. For example, two blocks or operations that are continuously shown can be actually performed at the same time, or they can sometimes be performed in reverse order according to the corresponding functions.

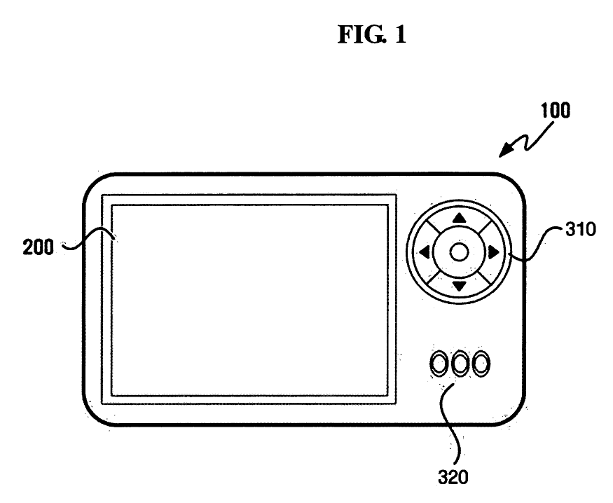

FIG. 1 is a diagram illustrating an apparatus for controlling texts of broadcasted data according to an embodiment of the present invention. As shown in FIG. 1, a portable apparatus 100 includes a display panel 200 and a plurality of input units 300, that is, input units 310 and 320. In this case, the portable apparatus 100 is carried by a user and provides moving pictures and a variety of information to the user. Examples of the portable apparatus 100 are cellular phones, PDAs (personal digital assistants), and PMPs (portable multimedia players).

The display panel 200 displays predetermined moving pictures and a variety of texts that are transmitted by a broadcasting station. According to aspects of this invention, where text data is transmitted and displayed, a user may adjust sizes of the displayed texts. For example, when the user selects a data broadcasting channel, broadcasting data of text types including character information, still image information, and product information are displayed on the display panel 200. In this case, the user may operate the input unit 300 to adjust the sizes of the displayed texts. Further, the user can set locations at which the texts are to be displayed.

Further, on a predetermined location of the display panel 200 (for example, the upper right side), menu items (for example, selectable menu items and currently selected menu items) are displayed, and a control bar to allow for an adjustment of sizes of the displayed texts is displayed. Here, when the user operates the control bar, the control bar moves to an enlarged region or a reduced region of the display panel 200 according to the button operation by the user.

Further, a method of loading the texts displayed on the display panel 200 may be provided as a method of scrolling rows of texts or a method of displaying words of texts in a one by one sequence. For example, it is assumed that predetermined texts are displayed on the display panel 200 according to the prescribed number of rows of texts (for example, five rows). First, text data of broadcasted data transmitted by the broadcasting station is decoded and displayed on the display panel 200. At this time, if the number of rows of the displayed texts is the same as the prescribed number of rows of texts, that is, if the texts of the first to fifth rows are displayed on the display panel 200, the texts of the first row displayed are scrolled after a predetermined time passes, and the texts of the second to sixth rows are displayed on the display panel 200. The above-mentioned processes are repeated until the received texts of all the rows (for example, ten rows) are displayed. In this case, a direction where the rows of the texts are scrolled corresponds to an ‘upward’ direction of the display panel 200.

The input unit 300 includes directional buttons 310 to allow for a control of movement of a cursor in vertical and horizontal directions and a plurality of functional buttons 320, each of which has an assigned function. The directional buttons 310 select movements in predetermined directions and predetermined icons (or items) according to the operation of the user. For example, the user may requests menu items using the functional buttons 320, and when the menu items are displayed, the user may select a desired menu item among the displayed menu items through the directional buttons 310. In addition, the user may adjust sizes of the displayed texts by using leftward and rightward buttons of the directional buttons 310. For example, the user may select a size adjusting item among the menu items such that a size adjusting function operates. Then, if the user selects the leftward button among the directional buttons 310, the sizes of the texts are reduced, and if the user selects the rightward button among the directional buttons 310, the sizes of the texts are enlarged. Meanwhile, when the user selects the directional buttons 310, different sound effects may be outputted for every direction of the respective buttons.

Accordingly, the user is able to adjust the sizes of the texts to desired sizes, and is able to determine a method of loading texts.

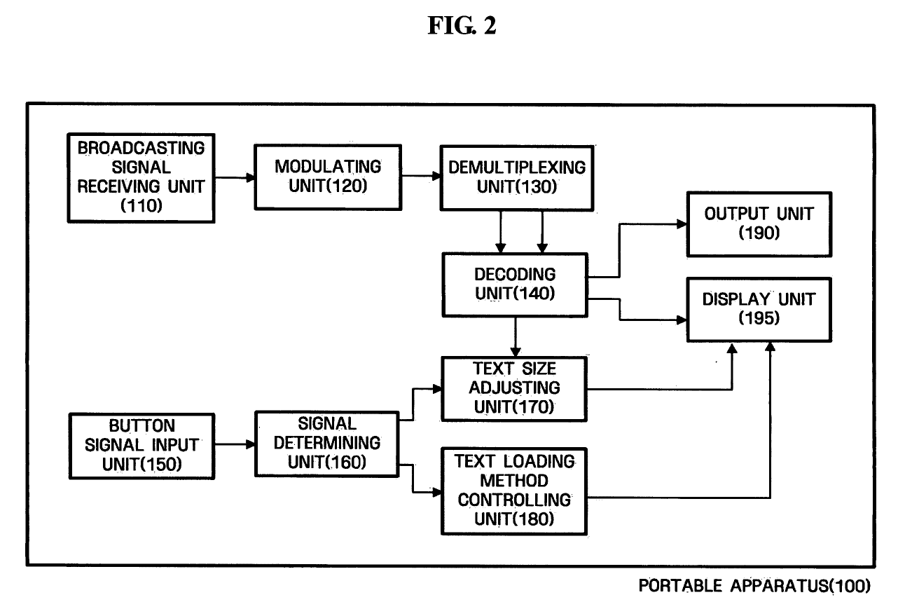

FIG. 2 is a block diagram illustrating an inner structure of an apparatus for controlling texts of broadcasted data according to another embodiment of the present invention. As shown in FIG. 2, the portable apparatus 100 includes a broadcasting signal receiving unit 110, a demodulating unit 120, a demultiplexing unit 130, a decoding unit 140, a button signal input unit 150, a signal determining unit 160, a text size adjusting unit 170, a text loading method controlling unit 180, an output unit 190, and a display unit 195.

At this time, each of the respective components in the embodiments, refers to, but is not limited to, a software or hardware component, such as a Field Programmable Gate Array (FPGA) or Application Specific Integrated Circuit (ASIC). A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a security multimedia card.

The broadcasting signal receiving unit 110 receives broadcasting signals (for example, video data, audio data, and text data) that are transmitted by a satellite DMB broadcasting station or a ground-wave DMB broadcasting station.

The demodulation unit 120 demodulates the broadcasting signals that are received by the broadcasting signal receiving unit 110, and the demultiplexing unit 130 restores the broadcasting signal that is demodulated by the demodulating unit 120. In this case, the demodulating unit 120 separates video data, audio data, and text data from the demodulated broadcasting signals and restores them. The decoding unit 140 decodes the broadcasting signals using an MPEG (Moving Picture Expert Group phase) system. In this case, the decoded audio data is outputted through the output unit 190, and the video data and the text data are displayed on the display panel 200 through the display unit 195. The button signal input unit 150 receives the button signals generated by the user (for example, directional button signals and functional button signals).

The signal determining unit 160 determines the nature of the button signals inputted through the button signal input unit 150. For example, if the inputted button signal is a signal indicating one of the directional buttons 310, the signal determining unit 160 checks the direction of the button indicated by the inputted signal (for example, leftward, rightward, upward, and downward), and allows the texts to move in the checked direction. Similarly, if the inputted button signal is a signal indicating one of the functional buttons 320, the signal determining unit 160 operates a function assigned to the corresponding button.

The text size adjusting unit 170 adjusts the sizes of the displayed texts according to a direction that is indicated by the button signal inputted through the button signal input unit 150. For example, if the user selects a leftward button of the directional buttons 310, the sizes of the displayed texts are reduced, and if the user selects a rightward button of the directional buttons 310, the sizes of the displayed texts are enlarged.

The text loading method control unit 180 determines a method of loading the texts displayed on the display panel 200. In this case, the text loading method refers to a method of scrolling rows of texts and a method of displaying words of texts one by one.

The output unit 190 outputs the interlocked effect sounds and audio data, when the text data and the moving picture are displayed on the display panel 200.

If the user selects the directional buttons 310, the output unit 190 outputs sound effects prescribed according to the respective directions. In this case, the outputted effect sounds may be arbitrarily set by the user.

The display unit 195 displays the text data and the moving pictures transmitted by the broadcasting station. Further, the display unit 195 displays a control bar to allow for a controlling of the predetermined menu items and text sizes.

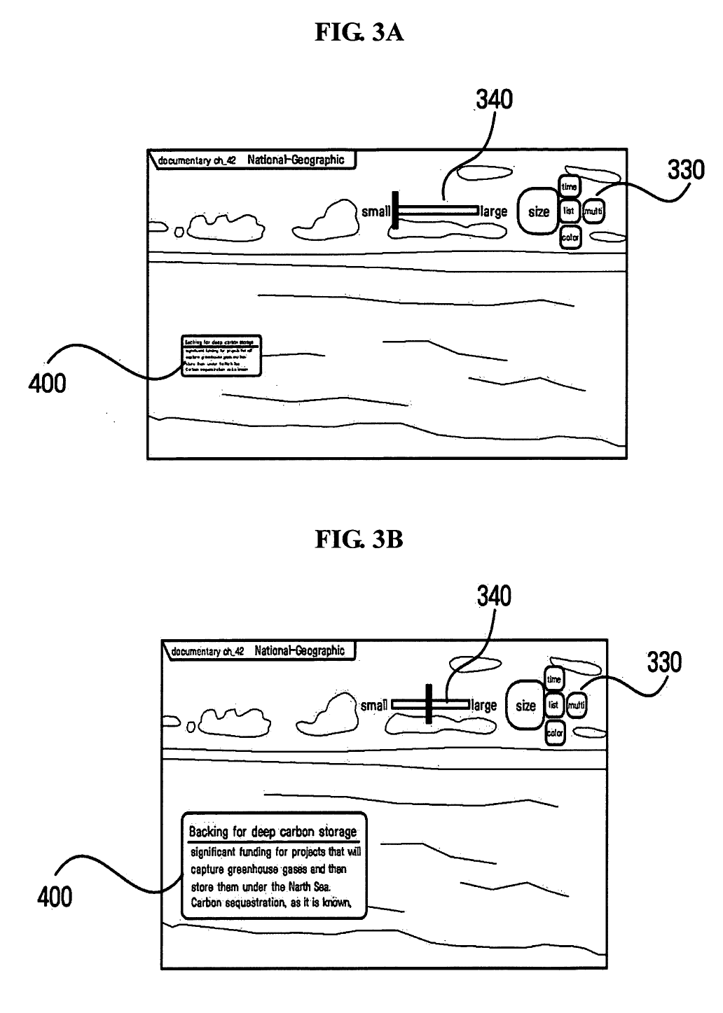

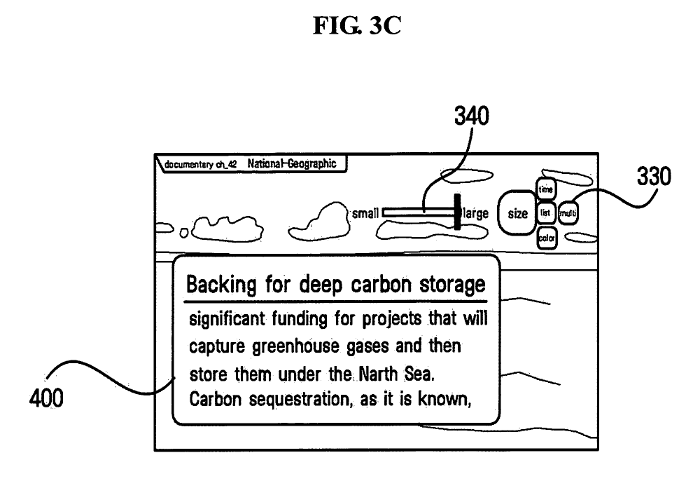

FIGS. 3A to 3C are diagrams illustrating an example where the sizes of texts are adjusted in the apparatus to control texts of the broadcasted data according to another embodiment of the present invention. As shown in FIG. 3A, predetermined sizes of texts 400, menu items 330, and a control bar 340 are displayed on the display panel 200. For example, if the user selects ‘the size adjusting item’ among the menu items by using the directional buttons 310, the currently selected menu item 330 is enlarged and displayed on the upper right side of the display panel 200, and the control bar 340 is displayed. In this case, if the user selects the directional button 310, the control bar moves in the same direction as the selected directional button 310. That is, the sizes of the displayed texts 400 are in a small state, and, thus, the control bar 340 is located on a region that indicates the reduction of the sizes of the texts.

As shown in FIG. 3B, if the user adjusts the sizes of the contents 400 to make them larger using the directional buttons 310, the sizes of the texts 400, which have been displayed in predetermined sizes according to the button selection of the user, are also enlarged accordingly. In detail, if the user selects the leftward button among the directional buttons 310, the sizes of the texts 400 are reduced, and if the user selects the rightward button among the directional buttons 310, the sizes of the texts 400 are enlarged.

Further, if the sizes of the displayed texts 400 are enlarged, the location of the displayed control bar 340 is changed to a region indicating the enlargement of the texts.

As shown in FIG. 3C, if the user enlarges the sizes of the texts 400 to the maximum by using the directional buttons 310, the texts 400 having been enlarged to the maximum are displayed on the display panel 200, and the location of the control bar 340 is changed to a region indicating the enlargement of the texts.

Meanwhile, if the user selects the directional buttons 310 for selecting the menu items and changing the sizes of the texts, the predetermined sound effects are outputted. Thus, it is possible to inform the user that the selected operation is performed. For example, when the user selects the menu items using the directional buttons 310, different water-drop sounds may be outputted in the respective directions. Where the user adjusts the sizes of the texts by selecting leftward and rightward buttons, if the sizes of the texts are enlarged, high-pitched sound effects are outputted, and if the sizes of the texts are reduced, low-pitched sound effects are outputted. In this case, the outputted effect sounds may be arbitrarily applied by the user.

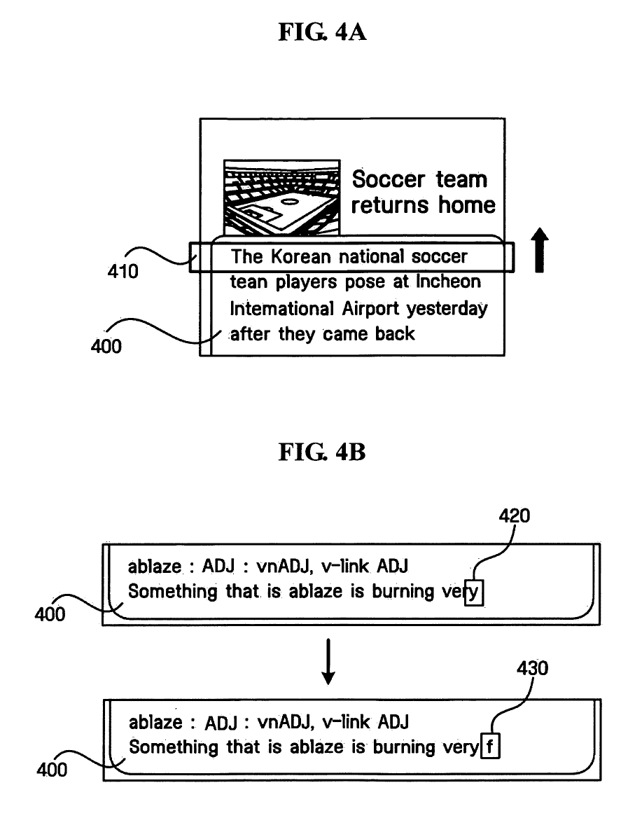

FIGS. 4A and 4B are diagrams illustrating a method of loading texts in the apparatus for controlling texts of broadcasted data according to another embodiment of the present invention. FIG. 4A is a diagram illustrating a method of scrolling rows of texts, and FIG. 4B is a diagram illustrating a method of displaying words of texts one by one. As shown in FIG. 4A, predetermined texts 400 are displayed on the display panel 200 according to the prescribed number of rows of texts. At this time, if the number of rows of the displayed texts is the same as the prescribed number of rows of texts, the first row of texts 410 is scrolled so as to display a next row of texts. In this case, a direction where the rows of the texts are scrolled corresponds to an ‘upward’ direction. Similarly, as shown in FIG. 4B, words of the texts received from the broadcasting station are displayed on the display panel 200 in a one by one sequence according to the prescribed number of rows of texts that can be displayed. For example, if the prescribed number of rows of texts is five, the words displayed can be displayed in up to five rows.

Then, if the prescribed number of rows of texts is the same as the number of rows of words, once all of the texts have been displayed, they may be deleted, and words of new texts may be displayed. For example, a word (or alphabet), that is, ‘very’ 420 is displayed on the displayed texts 400, and then a word (or letter), that is, an ‘f’ 430 is displayed.

Accordingly, the texts are provided according to the method of loading texts by which the user may read texts more easily, which results in increasing a recognition rate of texts by the users.

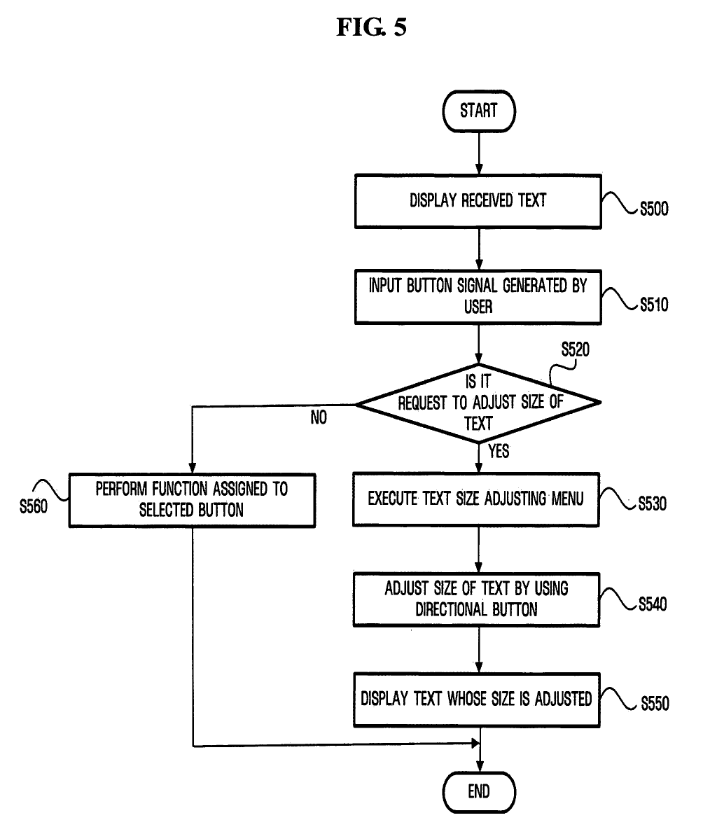

FIG. 5 is a flowchart illustrating a process of adjusting sizes of the displayed texts in a method of controlling texts of broadcasted data according to another embodiment of the present invention.

First, when the broadcasted data is transmitted, the transmitted data is received, and the received predetermined texts 400 are displayed on the display panel 200 (S500). In this case, the displayed texts 400 are displayed in the smallest sizes.

Then, in order for the user to adjust the sizes of the displayed texts, if the user selects ‘the size adjusting item’ among the menu items using the directional buttons 310, the button signal input unit 150 receives the button signal selected by the user (S510), and the signal determining unit 160 determines the nature of the button signal selected by the user.

As a result of the determination, if the user selects the text size adjusting item (S520), the text size adjusting menu is executed (S530). In this case, if the text size adjusting menu is executed, the currently selected menu item (that is, size adjusting item) 330 is enlarged and displayed on the upper right side of the display panel 200, and the control bar 340 to allow for a control of the sizes of the texts is displayed.

Then, if the user adjusts the sizes of the texts 400 by using the directional buttons 310 (S540), the text size adjusting unit 170 adjusts the sizes of the texts 400 displayed on the display panel 200.

For example, if the user selects the leftward button among the directional buttons 310, the sizes of the texts 400 are reduced, and if the user selects the rightward button among the directional buttons 310, the sizes of the texts 400 are enlarged. In this case, when the sizes of the texts 400 are changed, the location of the displayed control bar 340 is also changed. Further, if the user selects the directional buttons 310 so as to change the sizes of the texts, predetermined sound effects are outputted through the output unit 190.

Then, the display unit 195 displays the texts 400 whose sizes are changed according to the directional button 310 selected by the user on the display panel 200 (S550).

Meanwhile, as a result of the determination, if the user selects the predetermined functional button 320, the function assigned to the selected button is performed (S560).

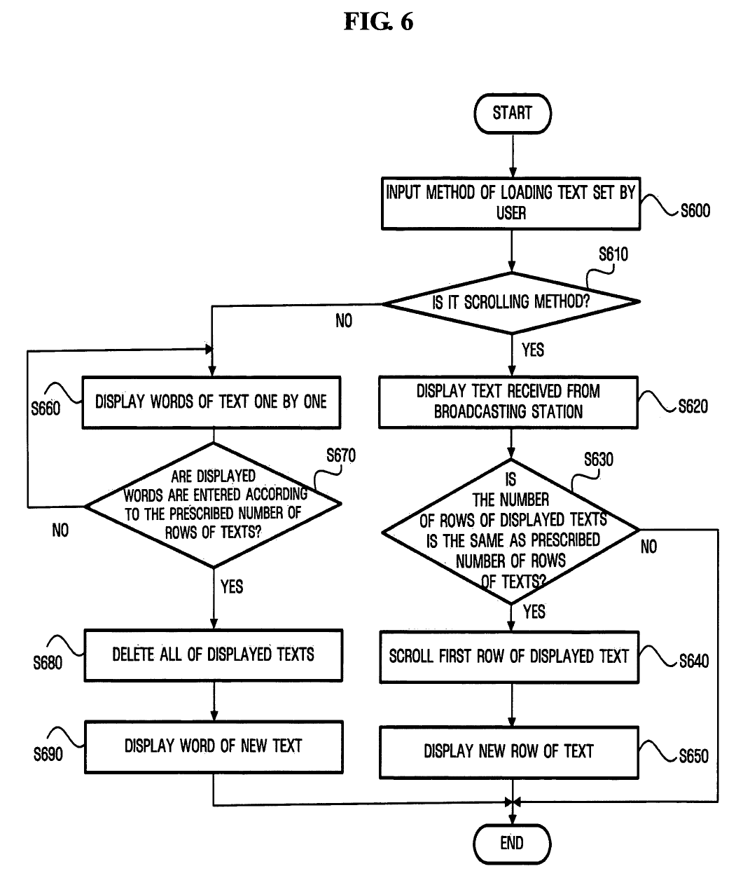

FIG. 6 is a flowchart illustrating a process of loading the texts in a method of controlling texts of broadcasted data according to another embodiment of the present invention.

First, the user selects a menu item to allow for a setting of a method of loading texts using the directional buttons 310, and sets the method of loading the texts through the displayed menu item. Then, the button signal input unit 150 receives the button signal indicating the button selected by the user (S600), and the signal determining unit 160 determines the method of loading texts set by the user through the inputted button signals.

As a result of the determination, if the method of loading the texts set by the user corresponds to the method of scrolling texts (S610), the texts 400 received from the broadcasting station are displayed on the display panel 200 through the display unit 105 (S620). In this case, the text loading method control unit 180 stores the method of loading texts set by the user, and the displayed texts 400 are displayed according to the prescribed number of rows of texts.

Then, if the number of rows of the displayed texts is the same as the prescribed number of rows of texts (S630), the first row of texts is scrolled so as to display a next row of texts (S640). In this case, a direction where the rows of the texts are scrolled corresponds to an ‘upward’ direction.

Then, if the first row of texts having been displayed is scrolled, a new row of texts not having been displayed is scrolled (S650).

For example, it is assumed that the total number of rows of texts having been received is ten, and the prescribed number of rows of texts that may be displayed is five.

First, the first to fifth rows of the received texts are displayed on the display panel 200. Then, the first row of displayed texts is scrolled and the sixth row is displayed on the display panel 200. In this case, the above-mentioned operation is repeated until the total rows of the received texts (for example, the ten rows) are displayed.

Meanwhile, as a result of the determination (S610), if the method of loading texts set by the user corresponds to a method of displaying words one by one, words (or alphabets) of the texts 400 transmitted by the broadcasting station are displayed on the display panel 200 one by one (S660). In this case, the displayed words (or alphabets) are displayed according to the prescribed number of rows of texts.

Then, if the number of rows of words having been displayed in the one by one sequence is the same as the prescribed number of rows of texts (S670), all of the words having been displayed are deleted (S680), and new words of texts are displayed in the one by one sequence (S690).

Meanwhile, the method of adjusting the sizes of the displayed texts 400 by using the directional buttons 310 illustrated in FIG. 5 and the method of loading the texts illustrated in FIG. 6 may be simultaneously used.

That is, the user may adjust the sizes of the texts 400 displayed on the display panel 200 through the operation of the directional buttons 310, and may apply the method of scrolling texts and the loading method for displaying the words one by one to the texts 400.

The apparatus for controlling the texts of the broadcasted data according to aspects of the present invention and the method of controlling the texts of the broadcasted data achieve the following effects. The user may adjust the sizes of the texts provided to the display panel of the portable apparatus to the desired sizes by using the directional buttons. Since a variety of methods of loading the texts provided to the display panel of the portable apparatus are provided, the user may read the texts more easily, which results in increasing the recognition ratio of the texts by the user. The different button sounds are outputted when the user selects the respective buttons, and the user may know through the outputted sound effects whether the selected operation is performed.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to control a size of text of broadcasted data, comprising:
a display unit to display the text when the broadcasted data is received;
a signal input unit to receive a signal inputted by a user; and
a text size adjusting unit to adjust the size of the displayed text according to the inputted signal.

2. The apparatus according to claim 1, wherein a control bar to adjust the size of the displayed text is displayed on a display panel of the display unit.

3. The apparatus according to claim 1, wherein, when the size of the displayed text is adjusted, sound effects are outputted according to enlargements and/or reductions in the size of the text.

4. The apparatus according to claim 1, wherein the signal input unit receives a button signal generated by the user.

5. The apparatus according to claim 1, wherein the text size adjusting unit adjusts the size of the displayed text according to directions indicated by the inputted button signals.

6. An apparatus to control a size of text of broadcasted data, comprising:
a display unit to display predetermined text when the broadcasted data is received;
a signal input unit to receive a signal inputted by a user; and
a text loading method control unit to control a loading of the displayed text according to the signals inputted by the user.

7. The apparatus according to claim 6, wherein the text is loaded via either a scrolling of rows of the displayed text or a displaying of words of the text in a one by one sequence.

8. The apparatus according to claim 6, wherein the signal input unit receives a button signal generated by the user.

9. An apparatus to allow for a control of text of broadcasted data, comprising:
a display panel to display predetermined text when the broadcasted data is received; and
an input unit to adjust a size of the displayed text.

10. The apparatus according to claim 9, wherein a control bar to allow for an adjustment of the size of the displayed text is displayed on the display panel.

11. The apparatus according to claim 9, wherein, when the size of the displayed text is adjusted, sound effects are outputted according to enlargements and reductions in the size of the text.

12. The apparatus according to claim 9, wherein the displayed text is loaded via either a scrolling of rows of the displayed text or a displaying of words of the text one by one.

13. A method of controlling text of broadcasted data, comprising:
displaying predetermined text on a display panel, when the broadcasted data is received;
receiving a signal inputted by a user; and
adjusting a size of the displayed text according to the inputted signal.

14. The method according to claim 13, wherein a control bar to allow for an adjustment of the size of the displayed text is displayed on the display panel.

15. The method according to claim 13, wherein, when the size of the displayed text is adjusted, sound effects are outputted according to enlargements and reductions in the size of the text.

16. The method according to claim 13, wherein a button signal generated by the user are inputted.

17. The method according to claim 13, wherein the text size is adjusted according to directions indicated by the inputted button signal.

18. A method of controlling text of broadcasted data, comprising:
displaying predetermined text on a display panel when the broadcasted data is received;
receiving a method of loading the text set by a user; and
loading the text on the display panel according to the method of loading the text set by the user.

19. The method according to claim 13, wherein the text is loaded via either a scrolling of rows of the displayed text or a displaying of words of the text in a one by one sequence.

20. A portable apparatus to allow for a controlling of texts of broadcasted data comprising:
a broadcasting signal receiving unit to receive broadcasting signals including the broadcasted data;
a decoder to demodulate the broadcasting signals, to separate text data from the broadcasting signals, and to decode the text data into the texts of broadcasted data;
a signal managing unit to receive an input signal from a user via buttons located on an exterior of the portable apparatus and to determine whether the input signal is a command to move the texts or to increase or decrease a size of the texts;
a text size adjusting unit to adjust the size of the texts if the command is to increase or decrease the size of the texts;
a text loading method controlling unit to determine a method of loading the texts to be displayed; and
an output and display unit to display the texts along with video and audio data included in the broadcasting signals on a display panel.

21. The apparatus according to claim 15, wherein the method of loading the texts comprises either a scrolling of rows of the displayed texts or a displaying of words of the texts in a one by one sequence.

22. A portable apparatus to allow for a control of texts of broadcasted data that are displayed by the apparatus, comprising:
a signal input unit to receive signals inputted by a user via buttons located on an exterior of the portable apparatus; and
a text size adjusting unit to adjust sizes of the displayed texts according to a direction indicated by the inputted signals.

23. The apparatus according to claim 17, wherein a control bar to adjust the sizes of the displayed texts is displayed on a display panel of the display unit.

24. The apparatus according to claim 17, wherein, when the sizes of the displayed texts are adjusted, sound effects are outputted according to enlargements and/or reductions in sizes of the texts.

25. A portable apparatus to allow for control of texts of broadcasted data that are displayed by the portable apparatus, comprising:
a signal input unit to receive signals inputted by a user via buttons located on an exterior of the portable apparatus; and
a text loading method control unit to control a loading of the displayed texts according to the setting of the method of loading the texts inputted by the user.

26. The apparatus according to claim 20, wherein the method of loading the texts comprises either a scrolling of rows of the displayed texts or a displaying of words of the texts in a one by one sequence.

27. A method of controlling texts of broadcasted data to be displayed on a portable apparatus, comprising:
displaying the texts when the broadcasted data is received;
receiving signals inputted by a user via buttons located on an exterior of the portable apparatus; and
adjusting sizes of the displayed texts according to directions indicated by the inputted signals.

28. The method according to claim 22, further comprising outputting sound effects when the sizes of the displayed texts are adjusted.

29. A method according to controlling texts of broadcasted data to be displayed on a portable apparatus, comprising:
displaying predetermined texts on a display panel when the broadcasted data is received;
receiving a method of loading the texts set by a user via buttons located on an exterior of the portable apparatus; and
loading the texts on the display panel according to the method of loading the texts set by the user.

30. The method according to claim 24, wherein the method of loading the texts comprises either a scrolling of rows of the displayed texts or a displaying of words of the texts in a one by one sequence.

31. A digital multimedia broadcasting (DMB) service compatible system comprising:
a portable apparatus to allow for a control of texts of broadcasted data that are displayed by the apparatus, the portable apparatus comprising:
a signal input unit to receive signals inputted by a user via buttons located on an exterior of the portable apparatus;
a text size adjusting unit to adjust sizes of the displayed texts according to a direction indicated by the inputted signals; and
a text loading method control unit to control a loading of the displayed texts according to the setting of the method of loading the texts inputted by the user.
